(19) United States
(12) Patent Application Publication
(10) Pub. No.: US 2025/0075736 A1
(43) Pub. Date: Mar. 6, 2025

(54) MAGNETIC LEVITATION DEVICE AND ROTOR POSITION ADJUSTMENT METHOD

(71) Applicant: SUZHOU SUPERMAG INTELLIGENT TECHNOLOGY CO., LTD, Suzhou, Jiangsu (CN)

(72) Inventor: Chengke Yin, Suzhou (CN)

(21) Appl. No.: 18/559,920

(22) PCT Filed: Nov. 3, 2023
(86) PCT No.: PCT/CN2022/129573

§ 371 Date: Nov. 9, 2023

(30) Foreign Application Priority Data
Dec. 21, 2021 (CN) 202111574244.7

(51) Int. Cl. F16C 32/04

(52) U.S. Cl. CPC F16C 32/0474

(57) ABSTRACT

A magnetic levitation device and a rotor position adjusting method are provided. The magnetic levitation device includes a rotor and a stator. In the axial direction of the stator, a permanent magnet stator body of the stator is sandwiched between a first magnetic stator substrate and a second magnetic stator substrate of the stator. The first magnetic stator substrate includes a first substrate body, as well as a first protrusion and a second protrusion protruding from the first substrate body toward the rotor, a first magnetic levitation coil is wound on the first protrusion, and a second magnetic levitation coil is wound on the second protrusion. In the axial direction of the stator, the first protrusion and the first magnetic levitation coil apply an upward force to the rotor while the second protrusion and the second magnetic levitation coil apply a downward force to the rotor.

### CROSS-REFERENCE TO RELATED APPLICATIONS

For all purposes, the present application is based on and claims the priority of Chinese Patent Application No. 202111574244.7 filed on Dec. 21, 2021, and the disclosure of the above-mentioned Chinese Patent Application is hereby incorporated in its entirety as a part of the present application.

### TECHNICAL FIELD

At least one embodiment of the present disclosure relates to the technical field of magnetic levitation, in particular to a magnetic levitation device and a rotor position adjusting method.

### BACKGROUND

Levitation technology mainly includes magnetic levitation, optical levitation, acoustic levitation, airflow levitation, electric levitation, particle beam levitation, etc., among which magnetic levitation technology has been developed more maturely. In the magnetic levitation technology, a magnetic interaction between a stator and a rotor causes the rotor to be levitated and rotated uniformly. There is no contact or mechanical friction between the rotor and the stator, so that the magnetic levitation technology is especially suitable for occasions requiring for high cleanliness levels.

### SUMMARY

According to the embodiments of the present disclosure, it is provided a magnetic levitation device, comprising: a rotor; and a stator, wherein the stator is arranged around the rotor or the rotor is arranged around the stator, the stator comprises a permanent magnet stator body, a first magnetic stator substrate and a second magnetic stator substrate, and the permanent magnet stator body is sandwiched between the first magnetic stator substrate and the second magnetic stator substrate in an axial direction of the stator, wherein, the first magnetic stator substrate comprises a first substrate body, as well as a first protrusion and a second protrusion which are protruding from the first substrate body towards the rotor, wherein a first magnetic levitation coil is wound on the first protrusion, and a second magnetic levitation coil is wound on the second protrusion, and the first protrusion is higher than the second protrusion in the axial direction of the stator so that the first protrusion and the first magnetic levitation coil apply an upward force in the axial direction on the rotor, and the second protrusion and the second magnetic levitation coil apply a downward force in the axial direction on the rotor.

For example, the first protrusion is higher than the second protrusion in the axial direction of the stator, comprising one of the following situations (i) to (iii): (i) in the axial direction of the stator, an upper surface of the first protrusion is higher than an upper surface of the second protrusion, and a lower surface of the first protrusion is higher than the upper surface of the second protrusion; (ii) in the axial direction of the stator, the upper surface of the first protrusion is higher than the upper surface of the second protrusion, and the lower surface of the first protrusion has a same height as the upper surface of the second protrusion; and (iii) in the axial direction of the stator, the upper surface of the first protrusion is higher than the upper surface of the second protrusion, and the lower surface of the first protrusion is located between the upper surface of the second protrusion and a lower surface of the second protrusion.

For example, the rotor comprises a rotor body, as well as a first flange and a second flange protruding from the rotor body towards the stator, wherein the first flange corresponds to the first magnetic stator substrate, and the second flange corresponds to the second magnetic stator substrate; under an initial levitation state of the rotor, a centerline of the first flange is substantially flush with a centerline of a distance between an upper surface of the first protrusion and a lower surface of the second protrusion in the axial direction of the stator; in the case where the upward force in the axial direction applied on the rotor by the first protrusion and the first magnetic levitation coil is greater than the downward force in the axial direction applied on the rotor by the second protrusion and the second magnetic levitation coil, the rotor moves upward in the axial direction of the stator from the initial levitation state; and in the case where the upward force in the axial direction applied on the rotor by the first protrusion and the first magnetic levitation coil is smaller than the downward force in the axial direction applied on the rotor by the second protrusion and the second magnetic levitation coil, the rotor moves downward in the axial direction of the stator from the initial levitation state.

For example, in the axial direction of the stator, a thickness of each of the first protrusion and the second protrusion is not smaller than a thickness of the first flange.

For example, the first magnetic stator substrate comprises a plurality of first protrusions and a plurality of second protrusions; and the first substrate body has a circular inner edge, and the plurality of first protrusions and the plurality of second protrusions are arranged along a circumferential direction of the circular inner edge.

For example, wherein sizes of the plurality of first protrusions along the circumferential direction of the circular inner edge are equal to each other, and sizes of the plurality of second protrusions along the circumferential direction of the circular inner edge are equal to each other.

For example, one second protrusion is arranged between two adjacent first protrusions, and one first protrusion is arranged between two adjacent second protrusions; the total number of the plurality of first protrusions is equal to the total number of the plurality of second protrusions; and the plurality of first protrusions are uniformly arranged along the circumferential direction of the circular inner edge, and the plurality of second protrusions are uniformly arranged along the circumferential direction of the circular inner edge.

For example, a size of each of the plurality of first protrusions along the circumferential direction of the circular inner edge is equal to a size of each of the plurality of second protrusions along the circumferential direction of the circular inner edge.

For example, one group of second protrusions is arranged between two adjacent first protrusions, and one first protrusion is arranged between two adjacent groups of second protrusions; one group of second protrusions comprises N second protrusions, where N≥2; the total number of the second protrusions is N times that of the first protrusions; and the plurality of first protrusions are uniformly arranged along the circumferential direction of the circular inner edge, and a plurality of groups of second protrusions are uniformly arranged along the circumferential direction of the circular inner edge.

For example, one group of first protrusions is arranged between two adjacent second protrusions, and one second protrusion is arranged between two adjacent groups of first protrusions; one group of first protrusions comprises M first protrusions, where M≥2; the total number of the first protrusions is M times that of the second protrusions; and a plurality of groups of first protrusions are uniformly arranged along the circumferential direction of the circular inner edge, and the plurality of second protrusions are uniformly arranged along the circumferential direction of the circular inner edge.

For example, one group of second protrusions is arranged between two adjacent groups of first protrusions, and one group of first protrusions is arranged between two adjacent groups of second protrusions; one group of second protrusions comprises N second protrusions, where N≥2, and one group of first protrusions comprises M first protrusions, where M≥2, and N is equal to or different from M; and a plurality of groups of first protrusions are uniformly arranged along the circumferential direction of the circular inner edge, and a plurality of groups of second protrusions are uniformly arranged along the circumferential direction of the circular inner edge.

For example, in the axial direction of the stator, a thickness of the first protrusion is equal to a thickness of the second protrusion.

For example, wherein the first protrusion and the second protrusion do not overlap in the axial direction of the stator.

For example, the first magnetic stator substrate comprises a first sub-substrate and a second sub-substrate, the first sub-substrate comprises the first protrusion, and the second sub-substrate comprises the second protrusion, and the first sub-substrate is stacked on the second sub-substrate in the axial direction of the stator so that the first protrusion is higher than the second protrusion in the axial direction of the stator.

For example, a shape and a size of the first sub-substrate comprising the first protrusion are as same as a shape and a size of the second sub-substrate comprising the second protrusion, respectively.

For example, the first substrate body has a circular inner edge; an inner edge of the first protrusion is a first arc, and an inner edge of the second protrusion is a second arc, wherein the first arc is a part of a first circle and the second arc is a part of a second circle; and the first circle and the second circle both are concentric circles of the circular inner edge.

For example, a size of the first circle is equal to a size of the second circle.

For example, the second magnetic stator substrate comprises a second substrate body and a plurality of teeth protruding from the second substrate body towards the rotor, and each of the plurality of teeth is wound with a magnetic rotating coil.

For example, an additional magnetic levitation coil is wound on the second substrate body, and the additional magnetic levitation coil is farther away from the rotor than the magnetic rotating coil.

For example, the second magnetic stator substrate further comprises a third protrusion and a fourth protrusion which are protruding from the second substrate body towards the rotor, wherein a third magnetic levitation coil is wound on the third protrusion, and a fourth magnetic levitation coil is wound on the fourth protrusion, and the third magnetic levitation coil and the fourth magnetic levitation coil are used as the additional magnetic levitation coil, and the third protrusion is higher than the fourth protrusion in the axial direction of the stator, so that the third protrusion and the third magnetic levitation coil apply an upward force in the axial direction on the rotor while the fourth protrusion and the fourth magnetic levitation coil apply a downward force in the axial direction on the rotor.

For example, the first magnetic stator substrate comprises a plurality of teeth protruding from the first substrate body towards the rotor, and each of the plurality of teeth is wound with an additional magnetic rotating coil, and the first magnetic levitation coil and the second magnetic levitation coil are both farther away from the rotor than the additional magnetic rotating coil.

For example, an inner edge of the first protrusion and an inner edge of the second protrusion are respectively provided with a part of the plurality of teeth.

For example, the first magnetic stator substrate comprises a first sub-substrate, a second sub-substrate and a third sub-substrate, wherein the first sub-substrate comprises the first protrusion, the second sub-substrate comprises the second protrusion, and the third sub-substrate comprises the plurality of teeth, the first sub-substrate is stacked on the second sub-substrate in the axial direction of the stator so that the first protrusion is higher than the second protrusion in the axial direction of the stator, and the third sub-substrate is sandwiched between the first sub-substrate and the second sub-substrate in the axial direction of the stator.

For example, in the axial direction of the stator, the first magnetic stator substrate is located below the second magnetic stator substrate.

According to the embodiments of the present disclosure, it is provided a rotor position adjusting method for adjusting a position of the rotor of the aforementioned magnetic levitation device in the axial direction of the stator, the rotor position adjusting method comprising: applying a first current to the first magnetic levitation coil and applying a second current to the second magnetic levitation coil; controlling the first current to control a magnitude of the upward force in the axial direction applied on the rotor by the first protrusion and the first magnetic levitation coil; and controlling the second current to control a magnitude of the downward force in the axial direction applied on the rotor by the second protrusion and the second magnetic levitation coil.

For example, the rotor position adjusting method further comprises: increasing the first current and/or decreasing the second current, so that the upward force in the axial direction applied on the rotor by the first protrusion and the first magnetic levitation coil is greater than the downward force in the axial direction applied on the rotor by the second protrusion and the second magnetic levitation coil, and the rotor moves upward in the axial direction of the stator under an upward resultant force; and decreasing the first current and/or increasing the second current, so that the upward force in the axial direction applied on the rotor by the first protrusion and the first magnetic levitation coil is smaller than the downward force in the axial direction applied on the rotor by the second protrusion and the second magnetic levitation coil, and the rotor moves downward in the axial direction of the stator under a downward resultant force.

For example, the first magnetic stator substrate comprises a plurality of first protrusions and a plurality of second protrusions; the first substrate body has a circular inner edge, and the plurality of first protrusions and the plurality of second protrusions are arranged along a circumferential direction of the circular inner edge; the rotor position adjusting method comprises: increasing a sum of first currents applied on a plurality of first magnetic levitation coils and/or decreasing a sum of second currents applied on a plurality of second magnetic levitation coils, so that the upward force in the axial direction applied on the rotor by the plurality of first protrusions and the plurality of first magnetic levitation coils is greater than the downward force in the axial direction applied on the rotor by the plurality of second protrusions and the plurality of second magnetic levitation coils, and the rotor moves upward in the axial direction of the stator under an upward resultant force; and decreasing the sum of the first currents applied on the plurality of first magnetic levitation coils and/or increasing the sum of the second currents applied on the plurality of second magnetic levitation coils, so that the upward force in the axial direction applied on the rotor by the plurality of first protrusions and the plurality of first magnetic levitation coils is smaller than the downward force in the axial direction applied on the rotor by the plurality of second protrusions and the plurality of second magnetic levitation coils, and the rotor moves downward in the axial direction of the stator under a downward resultant force.

### BRIEF DESCRIPTION OF THE DRAWINGS

In order to more clearly illustrate the technical solutions of the embodiments of the present disclosure, the drawings of the embodiments will be briefly described in the following; it is obvious that the described drawings are only related to some embodiments of the present disclosure and thus are not limitative to the present disclosure.

FIG. 1a is a schematic diagram of an exploded structure of a magnetic levitation device according to an embodiment of the present disclosure;

FIG. 1b is a schematic diagram of an elevation structure of a first magnetic stator substrate in a magnetic levitation device according to an embodiment of the present disclosure;

FIG. 1c is another schematic diagram of the elevation structure of the first magnetic stator substrate in the magnetic levitation device according to an embodiment of the present disclosure;

FIGS. 2a, 2b and 2c are schematic diagrams illustrating relative positional relationship between a first protrusion and a second protrusion in an axial direction of a stator in a magnetic levitation device according to embodiments of the present disclosure, respectively;

FIGS. 3a, 3b and 3c are schematic diagrams illustrating arrangements of a plurality of first protrusions and a plurality of second protrusions in a magnetic levitation device according to embodiments of the present disclosure, wherein one second protrusion is arranged between two adjacent first protrusions, and one first protrusion is arranged between two adjacent second protrusions;

FIG. 4 is a schematic diagram illustrating an arrangement of a plurality of first protrusions and a plurality of second protrusions in a magnetic levitation device according to an embodiment of the present disclosure, wherein one group of second protrusions is arranged between two adjacent first protrusions, and one first protrusion is arranged between two adjacent groups of second protrusions;

FIG. 5 is a schematic diagram illustrating an arrangement of a plurality of first protrusions and a plurality of second protrusions in a magnetic levitation device according to an embodiment of the present disclosure, wherein one group of first protrusions is arranged between two adjacent second protrusions, and one second protrusion is arranged between two adjacent groups of first protrusions;

FIG. 6 is a schematic diagram illustrating an arrangement of a plurality of first protrusions and a plurality of second protrusions in a magnetic levitation device according to an embodiment of the present disclosure, wherein one group of second protrusions is arranged between two adjacent groups of first protrusions, and one group of first protrusions is arranged between two adjacent groups of second protrusions;

FIG. 7 is a schematic diagram of an exploded structure of a first magnetic stator substrate in a magnetic levitation device according to an embodiment of the present disclosure;

FIGS. 8a and 8b are schematic structural diagrams of a first sub-substrate in a magnetic levitation device according to an embodiment of the present disclosure, respectively, wherein a first magnetic levitation coil is wound on a first protrusion in FIG. 8b;

FIGS. 9a and 9b are schematic structural diagrams of a second sub-substrate in a magnetic levitation device according to an embodiment of the present disclosure, respectively, wherein a second magnetic levitation coil is wound on a second protrusion in FIG. 9b;

FIG. 10a is a schematic diagram illustrating that an inner edge of a first protrusion in a magnetic levitation device according to an embodiment of the present disclosure is a part of a first circle;

FIG. 10b is a schematic diagram illustrating that an inner edge of a second protrusion in a magnetic levitation device according to an embodiment of the present disclosure is a part of a second circle;

FIGS. 11a and 11b are schematic structural diagrams of a second magnetic stator substrate in a magnetic levitation device according to an embodiment of the present disclosure, respectively, wherein a magnetic rotating coil and an additional magnetic levitation coil are illustrated in FIG. 11b;

FIG. 12 is a schematic diagram of an exploded structure of a second magnetic stator substrate in a magnetic levitation device according to an embodiment of the present disclosure;

FIG. 13 is another schematic diagram of the exploded structure of the first magnetic stator substrate in the magnetic levitation device according to an embodiment of the present disclosure; and

FIG. 14 is yet another schematic diagram of the exploded structure of the first magnetic stator substrate in the magnetic levitation device according to an embodiment of the present disclosure.

### DETAILED DESCRIPTION

In order to make objects, technical details and advantages of the embodiments of the present disclosure apparent, the technical solutions of the embodiments will be described in a clearly and fully understandable way in connection with the drawings related to the embodiments of the present disclosure. Apparently, the described embodiments are just a part but not all of the embodiments of the present disclosure. Based on the described embodiments herein, those skilled in the art can obtain other embodiment(s), without any inventive work, which should be within the scope of the present disclosure.

Unless otherwise defined, all the technical and scientific terms used herein have the same meanings as commonly understood by one of ordinary skill in the art to which the present disclosure belongs. The terms “first,” “second,” etc., which are used in the present disclosure, are not intended to indicate any sequence, amount or importance, but distinguish various components. Also, the terms “comprise,” “comprising,” “include,” “including,” etc., are intended to specify that the elements or the objects stated before these terms encompass the elements or the objects and equivalents thereof listed after these terms, but do not preclude the other elements or objects. The phrases “connect”, “connected”, etc., are not intended to define a physical connection or mechanical connection, but may include an electrical connection, directly or indirectly. “On,” “under,” “right,” “left” and the like are only used to indicate relative position relationship, and when the position of the object which is described is changed, the relative position relationship may be changed accordingly.

The drawings in the present disclosure are not drawn strictly to actual scales, and specific sizes and quantities of respective structures can be determined according to actual needs. The drawings described in the present disclosure are only schematic diagrams.

Embodiments of the present disclosure provide a magnetic levitation device and a rotor position adjusting method, which can simply, flexibly and accurately adjust a rotor position in an axial direction of a stator according to actual needs, improve controllability of the magnetic levitation device and allows for a broader application prospect of the magnetic levitation device.

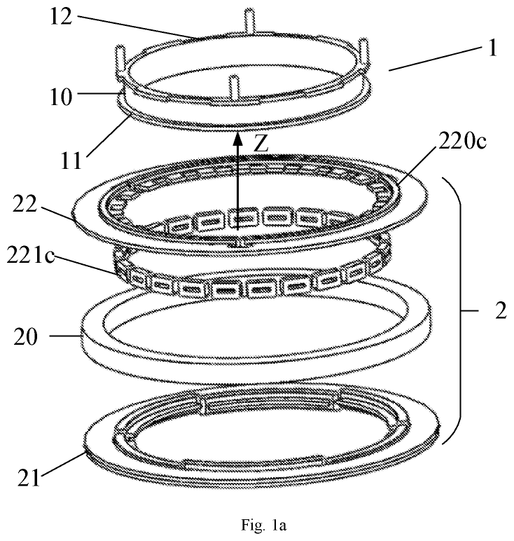

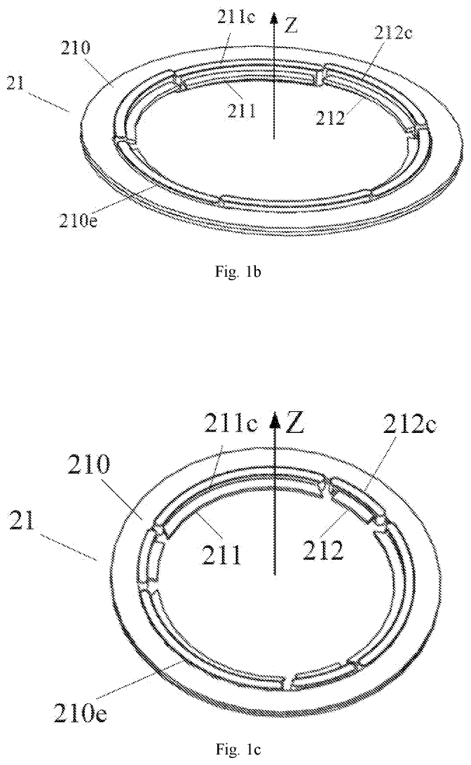

FIG. 1a is a schematic diagram of an exploded structure of a magnetic levitation device according to an embodiment of the present disclosure; and FIG. 1b is a schematic diagram of an elevation structure of a first magnetic stator substrate in a magnetic levitation device according to an embodiment of the present disclosure. Referring to FIGS. 1a and 1b, the magnetic levitation device according to the embodiment of the present disclosure includes a rotor 1 and a stator 2, the stator 2 is arranged around the rotor 1 or the rotor 1 is arranged around the stator 2; the stator 2 includes a permanent magnet stator body 20, a first magnetic stator substrate 21 and a second magnetic stator substrate 22, and the permanent magnet stator body 20 is sandwiched between the first magnetic stator substrate 21 and the second magnetic stator substrate 22 in an axial direction Z of the stator 2; the first magnetic stator substrate 21 includes a first substrate body 210, as well as a first protrusion 211 and a second protrusion 212 which are protruding from the first substrate body 210 towards the rotor; the first protrusion 211 is wound with a first magnetic levitation coil 211c, and the second protrusion 212 is wound with a second magnetic levitation coil 212c; the first protrusion 211 is higher than the second protrusion 212 in the axial direction Z of the stator, so that the first protrusion 211 and the first magnetic levitation coil 211c apply an upward force in the axial direction Z on the rotor 1, while the second protrusion 212 and the second magnetic levitation coil 212c apply a downward force in the axial direction Z on the rotor 1.

It should be explained that, for convenience of illustration, all the drawings illustrate the case where the stator 2 is arranged around the rotor 1. However, unless otherwise stated, the description of the embodiments of the present disclosure is also applicable to the case where the rotor 1 is arranged around the stator 2.

For example, a first current flows in the first magnetic levitation coil 211c, and a second current flows in the second magnetic levitation coil 212c. The rotor 1 is levitated by means of the actions of the first magnetic levitation coil 211c and the first protrusion 211, as well as the actions of the second magnetic levitation coil 212c and the second protrusion 212.

For example, according to the embodiment of the present disclosure, the stator 2 and the rotor 1 are spaced apart from each other; further, for example, in a stable levitation state of the rotor 1, the rotor 1 and the stator 2 are spaced apart from each other so that the rotor 1 and the stator 2 are not in contact with each other, thereby avoiding a series of problems such as heat generation and contamination caused by a mechanical friction. For example, in the case that the stator 2 and the rotor 1 are spaced apart from each other, other structure(s) may be provided in a gap between the stator 2 and the rotor 1 as required, or the stator 2 and the rotor 1 may be spaced apart from each other only by an air gap without providing any other structure therebetween.

For example, referring to FIG. 1a, the first magnetic stator substrate 21 is located below the second magnetic stator substrate 22 in the axial direction Z of the stator 2. However, the embodiment of the present disclosure is not limited to this, and the first magnetic stator substrate 21 may also be located above the second magnetic stator substrate 22 in the axial direction Z of the stator 2. Usually, other structure(s) may be arranged above the magnetic levitation device according to actual application environment; for convenience of installation, it is more desirable that the first magnetic stator substrate 21 is located below the second magnetic stator substrate 22 in the axial direction Z of the stator 2.

It should be explained that, for convenience of understanding, FIG. 1a is a schematic diagram of an exploded structure of a magnetic levitation device according to an embodiment of the present disclosure; in an actual structure, the first magnetic stator substrate 21 and the second magnetic stator substrate 22 are in direct contact with and fixed to the permanent magnet stator body 20, respectively, and the rotor 1 is accommodated in an accommodating cavity jointly defined by the first magnetic stator substrate 21, the permanent magnet stator body 20 and the second magnetic stator substrate 22; alternatively, the first magnetic stator substrate 21, the permanent magnet stator body 20 and the second magnetic stator substrate 22, together, are accommodated in an accommodating cavity defined by the rotor 1, so that the magnetic levitation device represents a flat shape as a whole.

For example, the upward force in the axial direction Z applied on the rotor 1 by the first protrusion 211 and the first magnetic levitation coil 211c means that the force applied on the rotor 1 by the first protrusion 211 and the first magnetic levitation coil 211c has an upward component in the axial direction Z but has no downward component in the axial direction Z; further, for example, the force applied on the rotor 1 by the first protrusion 211 and the first magnetic levitation coil 211c also has a component in a radial direction of the stator 2 in addition to the upward component in the axial direction Z. For example, in the case where a plurality of first protrusions 211 are provided, the upward components in the axial direction Z of the forces applied on the rotor 1 by the plurality of first protrusions 211 and the plurality of first magnetic levitation coils 211c form an upward resultant force in the axial direction Z. For example, in the case where the plurality of first protrusions 211 are provided, the components, in the radial direction of the stator 2, of the forces applied on the rotor 1 by the plurality of first protrusions 211 counteract with the components, in the radial direction of the stator 2, of the forces applied on the rotor 1 by the plurality of first magnetic levitation coils 211c, so that the rotor 1 is in a balanced state in the radial direction of the stator 2.

For example, the downward force in the axial direction Z applied on the rotor 1 by the second protrusion 212 and the second magnetic levitation coil 212c means that the force applied on the rotor 1 by the second protrusion 212 and the second magnetic levitation coil 212c has a downward component in the axial direction Z but has no upward component in the axial direction Z; further, for example, the force applied on the rotor 1 by the second protrusion 212 and the second magnetic levitation coil 212c also has a component in the radial direction of the stator 2 in addition to the downward component in the axial direction Z. For example, in the case where a plurality of second protrusions 212 are provided, the downward components in the axial direction Z of the forces applied on the rotor 1 by the plurality of second protrusions 212 and the plurality of second magnetic levitation coils 212c form a downward resultant force in the axial direction Z. For example, in the case where the plurality of second protrusions 212 are provided, the components, in the radial direction of the stator 2, of the forces applied on the rotor 1 by the plurality of second protrusions 212 counteract with the components, in the radial direction of the stator 2, of the forces applied on the rotor 1 by the plurality of second magnetic levitation coils 212c, so that the rotor 1 is in a balanced state in the radial direction of the stator 2.

According to an embodiment of the present disclosure, the first magnetic stator substrate 21 includes a first substrate body 210, as well as a first protrusion 211 and a second protrusion 212 which are protruding from the first substrate body 210 towards the rotor 1. The first protrusion 211 is higher than the second protrusion 212 in the axial direction Z of the stator, so that the first protrusion 211 and the first magnetic levitation coil 211c apply an upward force in the axial direction Z on the rotor 1, while the second protrusion 212 and the second magnetic levitation coil 212c apply a downward force in the axial direction Z on the rotor 1. Thus, a flexible adjustment of the position of the rotor 2 in the axial direction Z of the stator 2 can be realized by controlling the relationship between the magnitude of the upward force in the axial direction Z applied on the rotor 1 by the first protrusion 211 and the first magnetic levitation coil 211c and the magnitude of the downward force in the axial direction Z applied on the rotor 1 by the second protrusion 212 and the second magnetic levitation coil 212c. For example, if the upward force in the axial direction Z applied on the rotor 1 by the first protrusion 211 and the first magnetic levitation coil 211c is greater than the downward force in the axial direction Z applied on the rotor 1 by the second protrusion 212 and the second magnetic levitation coil 212c, the rotor 1 will move upward in the axial direction Z; if the upward force in the axial direction Z applied on the rotor 1 by the first protrusion 211 and the first magnetic levitation coil 211c is smaller than the downward force in the axial direction Z applied on the rotor 1 by the second protrusion 212 and the second magnetic levitation coil 212c, the rotor 1 will move downward in the axial direction Z. For example, a first current flows in the first magnetic levitation coil 211c, and a second current flows in the second magnetic levitation coil 212c. For example, by increasing the first current and/or decreasing the second current, the upward force in the axial direction Z applied on the rotor 1 by the first protrusion 211 and the first magnetic levitation coil 211c is greater than the downward force in the axial direction Z applied on the rotor 1 by the second protrusion 212 and the second magnetic levitation coil 212c, the rotor 1 moves upward in the axial direction Z of the stator 2 by a distance depending on the increased amount of the first current and/or the decreased amount of the second current; the greater the increased amount of the first current and/or the greater the decreased amount of the second current, the greater the distance of the upward movement. For example, by decreasing the first current and/or increasing the second current, the upward force in the axial direction Z applied on the rotor 1 by the first protrusion 211 and the first magnetic levitation coil 211c is smaller than the downward force in the axial direction Z applied on the rotor 1 by the second protrusion 212 and the second magnetic levitation coil 212c, the rotor 1 moves downward in the axial direction Z of the stator 2 by a distance depending on the decreased amount of the first current and/or the increased amount of the second current; the greater the decreased amount of the first current and/or the greater the increased amount of the second current, the greater the distance of the downward movement. Thus, in the magnetic levitation device according to the embodiment of the present disclosure, the position of the rotor 1 in the axial direction Z of the stator 2 can be simply, flexibly and accurately adjusted according to actual needs, thereby improving the controllability of the magnetic levitation device and allowing for a broader application prospect of the magnetic levitation device.

For example, the permanent magnet stator body 20 is formed of a permanently magnetic material, examples of which include but are not limited to samarium cobalt, neodymium iron boron (NdFeB) and ferrite.

For example, both the first magnetic stator substrate 21 and the second magnetic stator substrate 22 are formed of a magnetic material; further, for example, the magnetic material is a ferromagnetic material; further, for example, the ferromagnetic material is a soft magnetic material with a magnetoconductivity much greater than that of the vacuum, and examples thereof include but are not limited to iron, cobalt, nickel and their alloys, carbon steel, silicon steel, and electrotechnical pure iron.

For example, referring to FIGS. 1a and 1b, the first protrusion 211 and the second protrusion 212 do not overlap in the axial direction Z of the stator 2, so as to prevent the first magnetic levitation coil 211c wound on the first protrusion 211 and the second magnetic levitation coil 212c wound on the second protrusion 212 from overlapping with each other, because an overlap therebetween may result in an increase in the thickness of the first magnetic stator substrate 21 in the axial direction Z and hence result in an increase in the thickness of the entire magnetic levitation device. That is to say, the first protrusion 211 and the second protrusion 212 do not overlap in the axial direction Z of the stator 2, which is beneficial to thinning the entire magnetic levitation device. However, it should be explained that the first protrusion 211 and the second protrusion 212 may have no overlap, partially overlap or completely overlap in the axial direction Z of the stator 2, all of which allow for the position of the rotor 1 in the axial direction Z to be adjusted.

For example, with continued reference to FIG. 1a, the rotor 1 of the magnetic levitation device includes a rotor body 10, as well as a first flange 11 and a second flange 12 which are protruding from the rotor body 10 towards the stator 2. The first flange 11 corresponds to the first magnetic stator substrate 21, and the second flange 12 corresponds to the second magnetic stator substrate 22. For example, the rotor 1 is formed of a magnetic material, examples of which include but are not limited to a permanently magnetic material or a ferromagnetic material. Further, for example, the ferromagnetic material is a soft magnetic material with a magnetoconductivity much greater than that of the vacuum, and examples thereof include but are not limited to iron, cobalt, nickel and their alloys, carbon steel, silicon steel, and electrotechnical pure iron. Examples of permanently magnetic materials include, but are not limited to, samarium cobalt, neodymium iron boron (NdFeB) and ferrite. Because the first flange 11 corresponds to the first magnetic stator substrate 21, the upward force in the axial direction Z applied on the rotor 1 by the first protrusion 211 and the first magnetic levitation coil 211c and the downward force in the axial direction Z applied on the rotor 1 by the second protrusion 212 and the second magnetic levitation coil 212c both directly act on the first flange 11 of the rotor 1; an interaction between the first flange 11, and the first protrusion 211, the first magnetic levitation coil 211c, the second protrusion 212 and the second magnetic levitation coil 212c causes the rotor to be levitated.

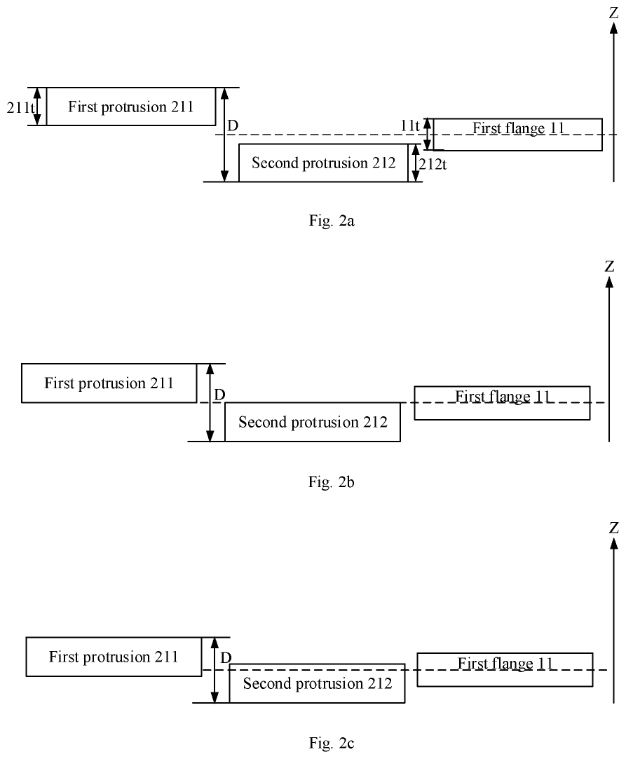

FIG. 2a, FIG. 2b and FIG. 2c are schematic diagrams illustrating the relative position relationship between the first protrusion 211 and the second protrusion 212 in the axial direction Z of the stator in the magnetic levitation device according to embodiments of the present disclosure, respectively. For example, as mentioned above, the first protrusion 211 is higher than the second protrusion 212 in the axial direction Z of the stator 2, which includes one of the following situations: (i) in the axial direction Z of the stator 2, an upper surface of the first protrusion 211 is higher than an upper surface of the second protrusion 212, and a lower surface of the first protrusion 211 is higher than the upper surface of the second protrusion 212, as illustrated in FIG. 2a; (ii) in the axial direction Z of the stator 2, the upper surface of the first protrusion 211 is higher than the upper surface of the second protrusion 212, and the lower surface of the first protrusion 211 has the same height as the upper surface of the second protrusion 212, as illustrated in FIG. 2b; and (iii) in the axial direction Z of the stator 2, the upper surface of the first protrusion 211 is higher than the upper surface of the second protrusion 212, and the lower surface of the first protrusion 211 is located between the upper surface of the second protrusion 212 and a lower surface of the second protrusion 212, as illustrated in FIG. 2c. All of the situations illustrated in FIG. 2a, FIG. 2b and FIG. 2c allow the first protrusion 211 and the first magnetic levitation coil 211c to apply an upward force in the axial direction Z on the rotor 1, and allow the second protrusion 212 and the second magnetic levitation coil 212c to apply a downward force in the axial direction Z on the rotor 1, so that the position of the rotor in the axial direction Z can be adjusted and controlled under a resultant action of the upward force in the axial direction Z and the downward force in the axial direction Z.

For example, in order to adjust the position of the rotor 1 in the axial direction Z by using the first protrusion 211 and the first magnetic levitation coil 211c as well as the second protrusion 212 and the second magnetic levitation coil 212c in a better way, it is desirable that the rotor 1 is located in a predetermined area in the axial direction Z. With continued reference to FIGS. 2a, 2b and 2c, the relative positional relationship between the first flange 11 of the rotor 1, and the first protrusion 211 and the second protrusion 212 in the axial direction Z is further illustrated. For example, under an initial levitation state of the rotor 1, in the axial direction Z of the stator 2, a centerline of the first flange 11 of the rotor 1 is substantially flush with a centerline of a distance D between the upper surface of the first protrusion 211 and the lower surface of the second protrusion 212. In the case that the upward force in the axial direction Z applied on the rotor 1 (specifically, on the first flange 11) by the first protrusion 211 and the first magnetic levitation coil 211c is greater than the downward force in the axial direction Z applied on the rotor 1 (specifically, on the first flange 11) by the second protrusion 212 and the second magnetic levitation coil 212c, the rotor 1 moves upward in the axial direction Z from the initial levitation state. In the case that the upward force in the axial direction Z applied on the rotor 1 (specifically, on the first flange 11) by the first protrusion 211 and the first magnetic levitation coil 211c is smaller than the downward force in the axial direction Z applied on the rotor 1 (specifically, on the first flange 11) by the second protrusion 212 and the second magnetic levitation coil 212c, the rotor 1 moves downward in the axial direction Z from the initial levitation state. For example, the initial levitation state of the rotor 1 refers to the state while the rotor 1 just starts to be stably levitated by introducing a first current into the first magnetic levitation coil 211c and introducing a second current into the second magnetic levitation coil 212c. For example, under the initial levitation state of the rotor 1, the first current flowing in the first magnetic levitation coil 211c is as same as the second current flowing in the second magnetic levitation coil 212c.

For example, further, in order to conveniently control the rotor 1 to be located in a predetermined area in the axial direction Z so as to adjust the position of the rotor 1 in the axial direction Z by using the first protrusion 211 and the first magnetic levitation coil 211c as well as the second protrusion 212 and the second magnetic levitation coil 212c in a better way, in the axial direction Z of the stator 2, a thickness 211t of the first protrusion 211 is not smaller than a thickness 11t of the first flange 11, and a thickness 212t of the second protrusion 212 is not smaller than the thickness 11t of the first flange 11. For example, referring to FIG. 2a, the thickness 211t of the first protrusion 211 is a size of the first protrusion 211 in the axial direction Z, the thickness 212t of the second protrusion 212 is a size of the second protrusion 212 in the axial direction Z, and the thickness 11t of the first flange 11 is a size of the first flange 11 in the axial direction Z.

For example, for convenience of manufacture and control, in the axial direction Z of the stator 2, the thickness 211t of the first protrusion 211 is equal to the thickness 212t of the second protrusion 212. However, the embodiment of the present disclosure is not limited to this, and the thickness 211t of the first protrusion 211 may not be equal to the thickness 212t of the second protrusion 212 in the axial direction Z of the stator 2.

It should be explained that FIGS. 2a, 2b and 2c are only schematic diagrams for illustrating the relative positional relationship among the first protrusion 211, the second protrusion 212 and the first flange 1 in the axial direction Z of the stator 2; in FIGS. 2a, 2b and 2c, for convenience of illustration, the arrangement manner of the first protrusion 211, the second protrusion 212 and the first flange 1 in the radial direction perpendicular to the axial direction Z is not taken into consideration.

FIG. 1c is another schematic diagram of the elevation structure of the first magnetic stator substrate in the magnetic levitation device according to an embodiment of the present disclosure. For example, referring to FIGS. 1b and 1c, the first magnetic stator substrate 21 includes a plurality of first protrusions 211 and a plurality of second protrusions 212; the first substrate body 210 has a circular inner edge 210e, and the plurality of first protrusions 211 and the plurality of second protrusions 212 are arranged along a circumferential direction of the circular inner edge 210e. When a plurality of first protrusions 211 and a plurality of second protrusions 212 are provided, there may be a plurality of force application points at which force can be applied to the rotor 1, so that the control effect on the rotor 1 is better. For example, with continued reference to FIGS. 1b and 1c, sizes of the plurality of first protrusions 211 along the circumferential direction of the circular inner edge 210e of the first substrate body 210 are equal to each other, and sizes of the plurality of second protrusions 212 along the circumferential direction of the circular inner edge 210e of the first substrate body 210 are equal to each other, so that the force applied on the rotor 1 is uniform. However, the embodiment of the present disclosure is not limited to this, and the sizes of the plurality of first protrusions 211 along the circumferential direction of the circular inner edge 210e of the first substrate body 210 may be different, and the sizes of the plurality of second protrusions 212 along the circumferential direction of the circular inner edge 210e of the first substrate body 210 may also be different, which can be flexibly designed according to the actual situation. In the case where the sizes of the plurality of first protrusions 211 along the circumferential direction of the circular inner edge 210e of the first substrate body 210 are equal to each other and the sizes of the plurality of second protrusions 212 along the circumferential direction of the circular inner edge 210e of the first substrate body 210 are equal to each other, the size of each of the plurality of first protrusions 211 along the circumferential direction of the circular inner edge 210e of the first substrate body 210 is, for example, equal to each of the plurality of second protrusions 212 along the circular inner edge 210e of the first substrate body 210, as illustrated in FIG. 1b. The size of each of the plurality of first protrusions 211 in the circumferential direction of the circular inner edge 210e of the first substrate body 210 is, for example, different from the size of each of the plurality of second protrusions 212 in the circumferential direction of the circular inner edge 210e of the first substrate body 210, as illustrated in FIG. 1c.

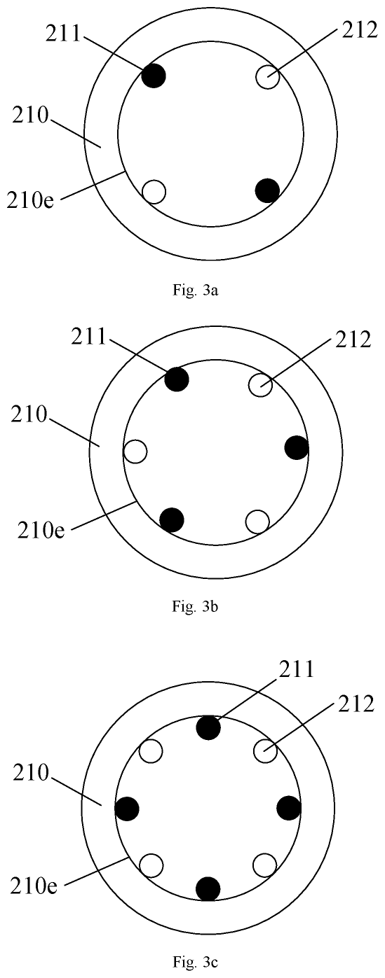

The arrangement manner of the first protrusion 211 and the second protrusion 212 in the axial direction Z has been described above with reference to FIGS. 2a to 2c, and the arrangement manner of the first protrusion 211 and the second protrusion 212 in the circumferential direction of the first substrate body 210 will be described below with reference to FIGS. 3a to 3c and FIGS. 4 to 6. It should be explained that in FIGS. 3a to 3c and FIGS. 4 to 6, for convenience of illustration, the actual shapes of the first protrusion 211 and the second protrusion 212 are not taken into consideration, but the first protrusion 211 is simply represented by a solid circle and the second protrusion 212 is simply represented by a hollow circle.

For example, referring to FIGS. 3a to 3c, one second protrusion 212 is arranged between two adjacent first protrusions 211, and one first protrusion 211 is arranged between two adjacent second protrusions 212. The total number of the plurality of first protrusions 211 is equal to the total number of the plurality of second protrusions 212; furthermore, a plurality of first protrusions 211 are uniformly arranged along the circumferential direction of the circular inner edge 210e of the first substrate body 210, and a plurality of second protrusions 212 are uniformly arranged along the circumferential direction of the circular inner edge 210e of the first substrate body 210. As an example, it is illustrated in FIG. 3a that the total number of the first protrusions 211 and the total number of the second protrusions 212 are both two; it's illustrated in FIG. 3b that the total number of the first protrusions 211 and the total number of the second protrusions 212 are both three; and it's illustrated in FIG. 3c that the total number of the first protrusions 211 and the total number of the second protrusions 212 are both four. However, the embodiment of the present disclosure is not limited to this, and the total number of the first protrusions 211 and the total number of the second protrusions 212 may be arbitrarily set as required. In FIGS. 3a to 3c, a plurality of first protrusions 211 and a plurality of second protrusions 212 are alternately arranged one by one, the plurality of first protrusions 211 are uniformly arranged along the circumferential direction of the circular inner edge 210e of the first substrate body 210, and the plurality of second protrusions 212 are uniformly arranged along the circumferential direction of the circular inner edge 210e of the first substrate body 210, so that the force applied on the rotor 1 in the circumferential direction can be uniform, thereby achieving better control of the rotor 1. Further, for example, a plurality of first protrusions 211 and a plurality of second protrusions 212 both are uniformly arranged along the circumferential direction of the circular inner edge 210e of the first substrate body 210, so that the force applied on the rotor 1 in the circumferential direction is more uniform. Further, for example, the size of each of the plurality of first protrusions 211 along the circumferential direction of the circular inner edge 210e of the first substrate body 210 is equal to the size of each of the plurality of second protrusions 212 along the circumferential direction of the circular inner edge 210e of the first substrate body 210, so that the force applied on the rotor 1 in the circumferential direction is more uniform. However, the embodiment of the present disclosure is not limited to this. The plurality of first protrusions 211 may be unevenly arranged along the circumferential direction of the circular inner edge 210e of the first substrate body 210, the plurality of second protrusions 212 may be unevenly arranged along the circumferential direction of the circular inner edge 210e of the first substrate body 210, the size of each of the plurality of first protrusions 211 along the circumferential direction of the circular inner edge 210e of the first substrate body 210 may be different from the size of each of the plurality of second protrusions 212 along the circumferential direction of the circular inner edge 210e of the first substrate body 210, the sizes of the plurality of first protrusions 211 along the circumferential direction of the circular inner edge 210e of the first substrate body 210 may be different, and the sizes of the plurality of second protrusions 212 along the circumferential direction of the circular inner edge 210e of the first substrate body 210 may be different, all of which still enable the adjustment of the position of the rotor 1 in the axial direction Z.

For example, referring to FIG. 4, one group of second protrusions are arranged between two adjacent first protrusions 211, and one first protrusion 211 is arranged between two adjacent groups of second protrusions; one group of second protrusions includes N second protrusions, where N≥2; the total number of the second protrusions 212 is N times that of the first protrusions 211; a plurality of first protrusions 211 are uniformly arranged along the circumferential direction of the circular inner edge 210e of the first substrate body 210, and a plurality of groups of second protrusions are uniformly arranged along the circumferential direction of the circular inner edge 210e of the first substrate body 210. For example, in FIG. 4, the size of each of the plurality of first protrusions 211 along the circumferential direction of the circular inner edge 210e of the first substrate body 210 is greater than the size of each of the plurality of second protrusions 212 along the circumferential direction of the circular inner edge 210e of the first substrate body 210.

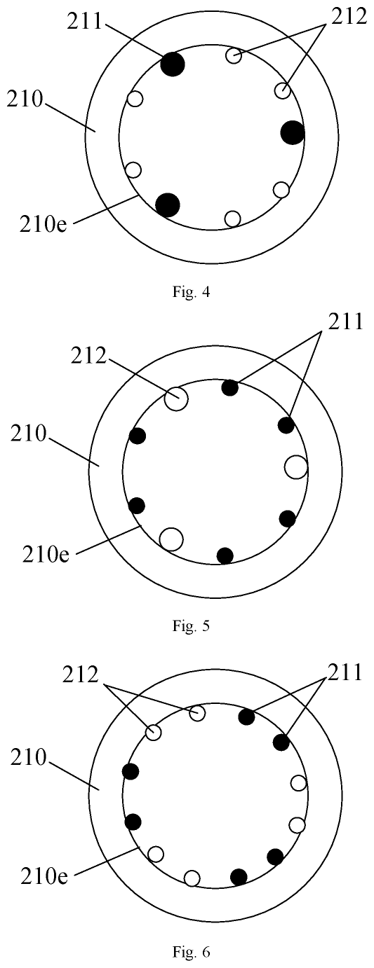

For example, referring to FIG. 5, one group of first protrusions is arranged between two adjacent second protrusions 212, and one second protrusion 212 is arranged between two adjacent groups of first protrusions; one group of first protrusions includes M first protrusions 211, where M≥2; the total number of the first protrusions 211 is M times that of the second protrusions 212; a plurality of groups of first protrusions are uniformly arranged along the circumferential direction of the circular inner edge 210e of the first substrate body 210, and a plurality of second protrusions 212 are uniformly arranged along the circumferential direction of the circular inner edge 210e of the first substrate body 210. For example, in FIG. 5, the size of each of the plurality of first protrusions 211 along the circumferential direction of the circular inner edge 210e of the first substrate body 210 is smaller than the size of each of the plurality of second protrusions 212 along the circumferential direction of the circular inner edge 210e of the first substrate body 210.

For example, referring to FIG. 6, one group of second protrusions are arranged between two adjacent groups of first protrusions, and one group of first protrusions are arranged between two adjacent groups of second protrusions; one group of second protrusions includes N second protrusions 212, where N≥2, and one group of first protrusions includes M first protrusions 211, where M≥2, and N is equal to or different from M; a plurality of groups of first protrusions are uniformly arranged along the circumferential direction of the circular inner edge 210e of the first substrate body 210, and a plurality of groups of second protrusions are uniformly arranged along the circumferential direction of the circular inner edge 210e of the first substrate body 210. For example, in FIG. 6, N is equal to M, and the size of each of the plurality of first protrusions 211 in the circumferential direction of the circular inner edge 210e of the first substrate body 210 is equal to the size of each of the plurality of second protrusions 212 in the circumferential direction of the circular inner edge 210e of the first substrate body 210.

In each of the embodiments of FIGS. 4 to 6, the force applied on the rotor 1 in the circumferential direction can be uniform, and the control effect on the rotor 1 can be improved. For example, in FIGS. 4 to 6, the plurality of first protrusions 211 have the same size along the circumferential direction of the circular inner edge 210e of the first substrate body 210, and the plurality of second protrusions 212 have the same size along the circumferential direction of the circular inner edge 210e of the first substrate body 210. However, the embodiment of the present disclosure is not limited to this. In FIGS. 4 to 6, the plurality of first protrusions 211 may be unevenly arranged along the circumferential direction of the circular inner edge 210e of the first substrate body 210, the plurality of groups of second protrusions may be unevenly arranged along the circumferential direction of the circular inner edge 210e of the first substrate body 210, the plurality of groups of first protrusions may be arranged unevenly along the circumferential direction of the circular inner edge 210e of the first substrate body 210, the plurality of second protrusions 212 may be arranged unevenly along the circumferential direction of the circular inner edge 210e of the first substrate body 210, the sizes of the plurality of first protrusions 211 along the circumferential direction of the circular inner edge 210e of the first substrate body 210 may be different, and the sizes of the plurality of second protrusions 212 along the circumferential direction of the circular inner edge 210e of the first substrate body 210 may be different, all of which still enable an adjustment of the position of the rotor 1 in the axial direction Z.

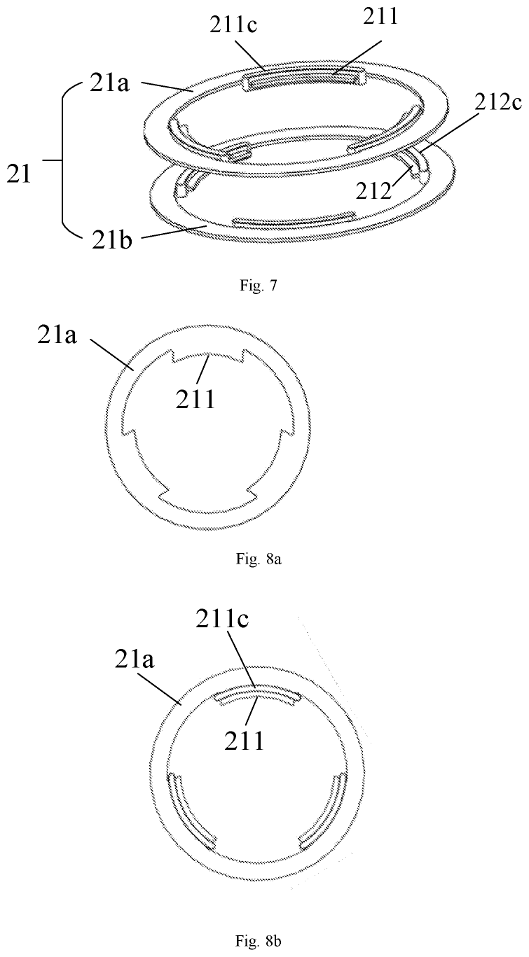

With continued reference to FIG. 1b, the first magnetic stator substrate 21 includes a first substrate body 210, as well as a first protrusion 211 and a second protrusion 212 which are protruding from the first substrate body 210 towards the rotor 1. There are many ways to realize this structure. As an example, an embodiment of the present disclosure will describe a simple and convenient way. FIG. 7 is a schematic diagram of an exploded structure of the first magnetic stator substrate 21 in the magnetic levitation device according to the embodiment of the present disclosure. Referring to FIG. 7, the first magnetic stator substrate 21 includes a first sub-substrate 21a and a second sub-substrate 21b; the first sub-substrate 21a includes a first protrusion 211, the second sub-substrate 21b includes a second protrusion 212, and the first sub-substrate 21a is stacked on the second sub-substrate 21b in the axial direction Z of the stator 2 so that the first protrusion 211 is higher than the second protrusion 212 in the axial direction Z of the stator 2. In the process of stacking the first sub-substrate 21a on the second sub-substrate 21b, the circumferential arrangement illustrated in any one of FIGS. 3a to 3c and FIGS. 4 to 5 can be realized very conveniently by rotating the first sub-substrate 21a or the second sub-substrate 21b around the axial direction Z. For example, for convenience of manufacture and control, the shape and size of the first sub-substrate 21a including the first protrusion 211 are the same as those of the second sub-substrate 21b including the second protrusion 212; that is, by rotating the first sub-substrate 21a or the second sub-substrate 21b around the axial direction Z, the first sub-substrate 21a and the second sub-substrate 21b can be completely coincident. However, the embodiment of the present disclosure is not limited to this, and the shape and size of the first sub-substrate 21a including the first protrusion 211 may be different from those of the second sub-substrate 21b including the second protrusion 212, in which case the position of the rotor 1 in the axial direction Z can still be adjusted.

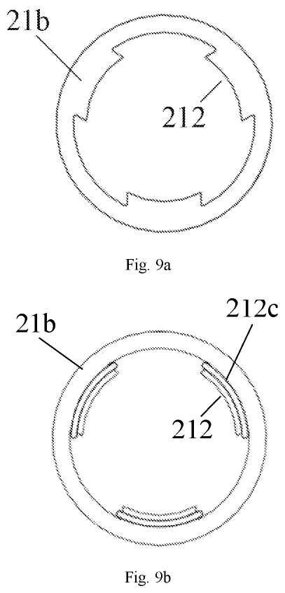

For example, FIG. 8a and FIG. 8b respectively illustrate schematic structural diagrams of the first sub-substrate 21a, in which the first magnetic levitation coil 211c is wound on the first protrusion 211 in FIG. 8b; FIGS. 9a and 9b respectively illustrate the schematic structural diagrams of the second sub-substrate 21b, in which the second magnetic levitation coil 212c is wound on the second protrusion 212 in FIG. 9b. For example, in FIGS. 7, 8a and 8b and FIGS. 9a and 9b, a portion of the first sub-substrate 21a other than the first protrusion 211 and a portion of the second sub-substrate 21b other than the second protrusion 212 constitute the first substrate body 210.

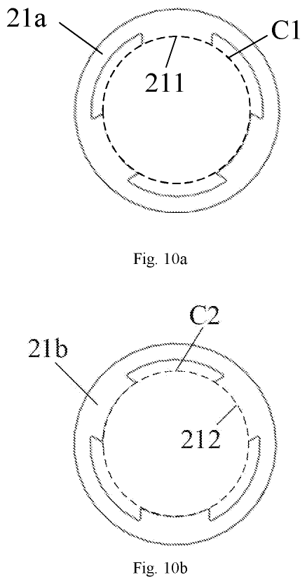

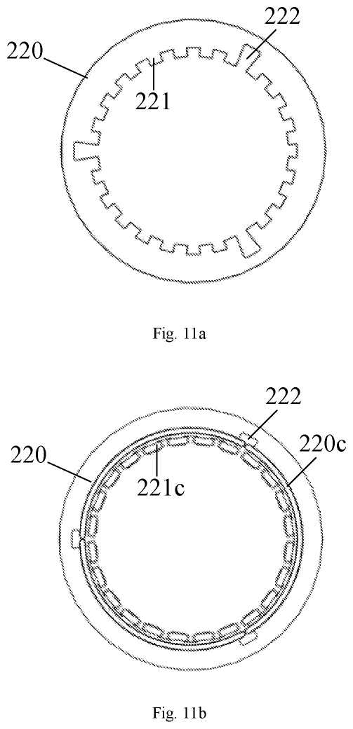

For example, referring to FIGS. 1b, 10a and 10b, the first substrate body 210 has a circular inner edge 210e; an inner edge of the first protrusion 211 is a first arc, and an inner edge of the second protrusion 212 is a second arc, wherein the first arc is a part of the first circle C1, and the second arc is a part of the second circle C2; and the first circle C1 and the second circle C2 both are concentric circles of the circular inner edge 210e of the first substrate body 210. In this case, the control effect on the rotor 1 can be improved. Further, for example, a size of the first circle C1 is equal to a size of the second circle C2, so that the control effect on the rotor 1 can be further improved. It should be explained that since the first protrusion 211 is higher than the second protrusion 212 in the axial direction Z of the stator 2, the first circle C1 is higher than the second circle C2.

FIGS. 11a and 11b are schematic structural diagrams of the second magnetic stator substrate 22 in the magnetic levitation device according to the embodiment of the present disclosure, respectively. Referring to FIGS. 11a and 11b, the second magnetic stator substrate 22 includes a second substrate body 220 and a plurality of teeth 221 protruding from the second substrate body 220 towards the rotor 1, and each tooth 221 is wound with a magnetic rotating coil 221c. The rotor 1 is rotated under the action of the magnetic rotating coil 221c. As mentioned above, the second magnetic stator substrate 22 corresponds to the second flange 12 of the rotor, thus an acting force applied on the rotor 1 by the second magnetic stator substrate 22 and the magnetic rotating coil 221c directly acts on the second flange 12 of the rotor 1; and the interaction between the second flange 12, and the second magnetic stator substrate 22 and the magnetic rotating coil 221c causes the rotor 1 to rotate.

For example, with continued reference to FIGS. 11a and 11b, the second substrate body 220 is wound with an additional magnetic levitation coil 220c, which is farther away from the rotor 1 than the magnetic rotating coil 221c. In this case, the additional magnetic levitation coil 220c, together with the first magnetic levitation coil 211c and the second magnetic levitation coil 212c as described above, enables the levitation of the rotor 1. Because a circumferential span of the additional magnetic levitation coil 220c is greater than that of the magnetic rotating coil 221c, the additional magnetic levitation coil 220c is arranged farther away from the rotor 1 than the magnetic rotating coil 221c, so as to prevent the magnetic rotating coil 221c from influencing a magnetic field distribution of the additional magnetic levitation coil 220c. However, the embodiment of the present disclosure is not limited to this, and the additional magnetic levitation coil 220c may be closer to the rotor 1 than the magnetic rotating coil 221c.

For example, the second magnetic stator substrate 22 includes a plurality of grooves 222 recessed from the second substrate body 220 in a direction away from the rotor 1, and the additional magnetic levitation coil 220c is wound on a portion of the second magnetic stator substrate 22 located between two adjacent grooves 222.

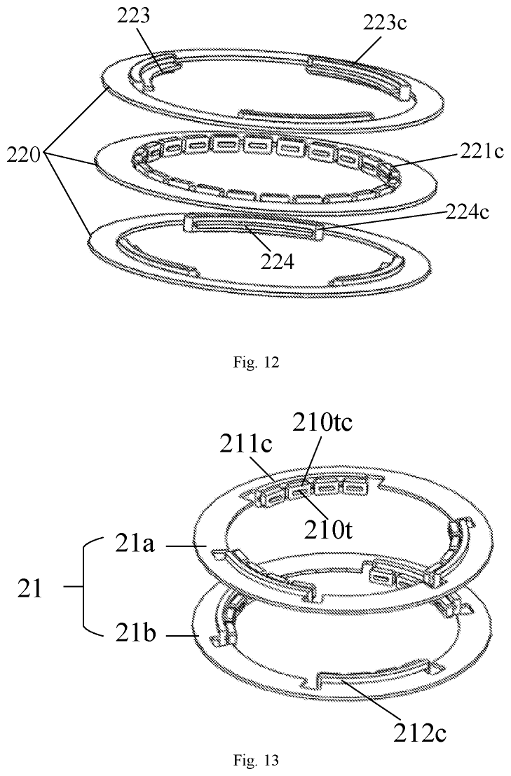

FIG. 12 is a schematic diagram of an exploded structure of the second magnetic stator substrate 22 in the magnetic levitation device according to the embodiment of the present disclosure. For example, referring to FIG. 12, the second magnetic stator substrate 22 further includes a third protrusion 223 and a fourth protrusion 224 which are protruding from the second substrate body 220 towards the rotor 1, wherein the third protrusion 223 is wound with a third magnetic levitation coil 223c, the fourth protrusion 224 is wound with a fourth magnetic levitation coil 224c, and the third magnetic levitation coil 223c and the fourth magnetic levitation coil 224c are used as the additional magnetic levitation coils 220c as described above; the third protrusion 223 is higher than the fourth protrusion 224 in the axial direction Z of the stator 2, so that the third protrusion 223 and the third magnetic levitation coil 223c apply an upward force in the axial direction Z on the rotor 1, while the fourth protrusion 224 and the fourth magnetic levitation coil 224c apply a downward force in the axial direction Z on the rotor 1. It should be explained that the second magnetic stator substrate 22 is arranged as a three-layered structure in FIG. 12, for convenience of processing and assembly; however, the embodiment of the present disclosure is not limited thereto. As mentioned above, the second magnetic stator substrate 22 corresponds to the second flange 12 of the rotor, thus the upward force in the axial direction Z applied on the rotor 1 by the third protrusion 223 and the third magnetic levitation coil 223c and the downward force in the axial direction Z applied on the rotor 1 by the fourth protrusion 224 and the fourth magnetic levitation coil 224c both directly act on the second flange 12 of the rotor 1; and the interaction between the second flange 12, and the third protrusion 223, the third magnetic levitation coil 223c, the fourth protrusion 224 and the fourth magnetic levitation coil 224c enables the rotor 1 to be levitated. The upward force in the axial direction Z applied on the rotor 1 by the first protrusion 211 and the first magnetic levitation coil 211c and the upward force in the axial direction Z applied on the rotor 1 by the third protrusion 223 and the third magnetic levitation coil 223c form a resultant upward force in the axial direction Z; the downward force in the axial direction Z applied on the rotor 1 by the second protrusion 212 and the second magnetic levitation coil 212c and the downward force in the axial direction Z applied on the rotor 1 by the fourth protrusion 224 and the fourth magnetic levitation coil 224c form a resultant downward force in the axial direction Z. By controlling the relationship between the magnitude of the resultant upward force in the axial direction Z and the magnitude of the resultant downward force in the axial direction Z, the position of the rotor 1 in the axial direction Z can be adjusted.

For example, regarding the relative positional relationship among the third protrusion 223, the fourth protrusion 224 and the second flange 12 in the axial direction Z of the stator 2, reference can be made to the relative positional relationship among the first protrusion 211, the second protrusion 212 and the first flange 11 in the axial direction Z of the stator 2, respectively, which will not be repeated here.

For example, regarding the circumferential arrangement, the thickness and the size of the third protrusion 223 and the fourth protrusion 224, reference can be made to the circumferential arrangement, the thickness and the size of the first protrusion 211 and the second protrusion 212, respectively, which will not be repeated here.

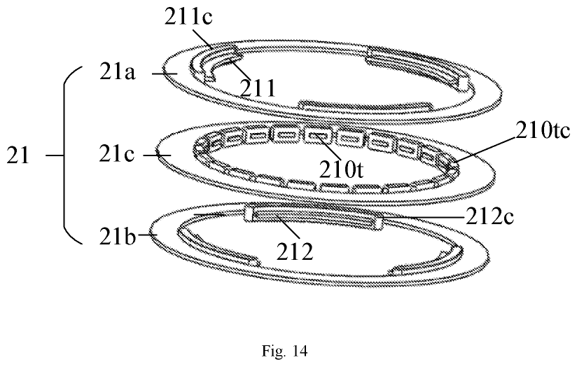

In FIGS. 1a and 1b, the first magnetic stator substrate 21 includes only magnetic levitation coils (specifically, the first magnetic levitation coil 211c and the second magnetic levitation coil 212c) and does not include a magnetic rotating coil; however, the embodiment of the present disclosure is not limited to this, and the first magnetic stator substrate 21 may further include a magnetic rotating coil in addition to the magnetic levitation coils. FIG. 13 is another schematic diagram of the exploded structure of the first magnetic stator substrate 21 in the magnetic levitation device according to the embodiment of the present disclosure; and FIG. 14 is yet another schematic diagram of the exploded structure of the first magnetic stator substrate 21 in the magnetic levitation device according to the embodiment of the present disclosure. Referring to FIGS. 13 and 14, the first magnetic stator substrate 21 includes a plurality of teeth 210t protruding from the first substrate body 210 towards the rotor 1, and each tooth 210t is wound with an additional magnetic rotating coil 210tc, and the first magnetic levitation coil 211c and the second magnetic levitation coil 212c are farther away from the rotor 1 than the additional magnetic rotating coil 210tc. Under a resultant action of the magnetic rotating coil 221c and the additional magnetic rotating coil 210tc as described above, the rotation of the rotor 1 is enabled. Because the first flange 11 corresponds to the first magnetic stator substrate 21, an acting force applied on the rotor 1 by the first magnetic stator substrate 21 and the additional magnetic rotating coil 210tc directly acts on the first flange 11, and the interaction between the first flange 11 of the rotor 1, and the first magnetic stator substrate 21 and the additional magnetic rotating coil 210tc enables the rotor 1 to be rotated. For example, the circumferential span of each of the first magnetic levitation coil 211c and the second magnetic levitation coil 212c is greater than that of the additional magnetic rotating coil 210tc, thus the first magnetic levitation coil 211c and the second magnetic levitation coil 212c are arranged farther away from the rotor 1 than the additional magnetic rotating coil 210tc, which can prevent the additional magnetic rotating coil 210tc from influencing the magnetic fields of the first magnetic levitation coil 211c and the second magnetic levitation coil 212c. However, the embodiment of the present disclosure is not limited to this, and the first magnetic levitation coil 211c and the second magnetic levitation coil 212c may also be arranged closer to the rotor 1 than the additional magnetic rotating coil 210tc.

For example, as illustrated in FIG. 13, the inner edge of the first protrusion 211 and the inner edge of the second protrusion 212 are respectively provided with a part of the plurality of teeth 210t. In order to facilitate processing and manufacturing, the first magnetic stator substrate 21 illustrated in FIG. 13 has a two-layered structure, that is, the first magnetic stator substrate 21 includes a first sub-substrate 21a and a second sub-substrate 21b.

For example, as illustrated in FIG. 14, the first magnetic stator substrate 21 includes a first sub-substrate 21a, a second sub-substrate 21b and a third sub-substrate 21c, wherein the first sub-substrate 21a includes a first protrusion 211, the second sub-substrate 21b includes a second protrusion 212, and the third sub-substrate 21c includes a plurality of teeth 210t; the first sub-substrate 21a is stacked on the second sub-substrate 21b in the axial direction Z of the stator 2 so that the first protrusion 211 is higher than the second protrusion 212 in the axial direction Z of the stator 2, and the third sub-substrate 21c is sandwiched between the first sub-substrate 21a and the second sub-substrate 21b in the axial direction Z of the stator 2. As a comparison, the first magnetic sub-substrate 21 in FIG. 14 is easier to be processed than the first magnetic sub-substrate 21 in FIG. 13; the first magnetic sub-substrate 21 in FIG. 13 is thinner than the first magnetic sub-substrate 21 in FIG. 14, which facilitates thinning the entire magnetic levitation device.

Based on the description above, it can be seen that in the magnetic levitation device according to the embodiment of the present disclosure, the first protrusion 211 and the first magnetic levitation coil 211c, the second protrusion 212 and the second magnetic levitation coil 212c, as well as the plurality of teeth 210t and the additional magnetic rotating coil 210tc are located at the same side of the permanent magnet stator body 20; the plurality of teeth 221, the magnetic rotating coil 221c and the additional magnetic levitation coil 220c are located at the same side of the permanent magnet stator body. As mentioned above, the first flange 11 of the rotor 1 corresponds to the first magnetic stator substrate 21, and the second flange 12 of the rotor 1 corresponds to the second magnetic stator substrate 22, thus the acting forces applied on the rotor 1 by the first protrusion 211 and the first magnetic levitation coil 211c, by the second protrusion 212 and the second magnetic levitation coil 212c, as well as by the plurality of teeth 210t and the additional magnetic rotating coil 210tc substantially directly act on the first flange 11 of the rotor 1, and the acting forces applied on the rotor 1 by the plurality of teeth 221, the magnetic rotating coil 221c and the additional magnetic levitation coil 220c substantially directly act on the second flange 12 of the rotor 1.

According to the embodiment of the present disclosure, there is further provided a rotor position adjusting method for adjusting the position of the rotor 1 of the above-described magnetic levitation device in the axial direction Z of the stator 2. For example, the rotor position adjusting method includes: applying a first current to the first magnetic levitation coil 211c and applying a second current to the second magnetic levitation coil 212c; controlling the first current to control the magnitude of the upward force in the axial direction Z applied on the rotor 1 by the first protrusion 211 and the first magnetic levitation coil 211c; and controlling the second current to control the magnitude of the downward force in the axial direction Z applied on the rotor 1 by the second protrusion 212 and the second magnetic levitation coil 212c.

For example, the rotor position adjusting method according to the embodiment of the present disclosure includes: increasing the first current and/or decreasing the second current, so that the upward force in the axial direction Z applied on the rotor 1 by the first protrusion 211 and the first magnetic levitation coil 211c is greater than the downward force in the axial direction Z applied on the rotor 1 by the second protrusion 212 and the second magnetic levitation coil 212c, and the rotor 1 moves upward in the axial direction Z of the stator 2 under an upward resultant force; and decreasing the first current and/or increasing the second current, so that the upward force in the axial direction Z applied on the rotor 1 by the first protrusion 211 and the first magnetic levitation coil 211c is smaller than the downward force in the axial direction Z applied on the rotor 1 by the second protrusion 212 and the second magnetic levitation coil 212c, and the rotor 1 moves downward in the axial direction Z of the stator 2 under a downward resultant force. For example, the distance that the rotor 1 moves upward in the axial direction Z of the stator 2 depends on the increased amount of the first current and/or the decreased amount of the second current; the greater the increased amount of the first current and/or the greater the decreased amount of the second current, the greater the distance of the upward movement. For example, the distance that the rotor 1 moves downward in the axial direction Z of the stator 2 depends on the decreased amount of the first current and/or the increased amount of the second current; the greater the decreased amount of the first current and/or the greater the increased amount of the second current, the greater the distance of the downward movement. Thus, the rotor position adjusting method according to the embodiment of the present disclosure can simply, flexibly and accurately adjust the position of the rotor 1 in the axial direction Z of the stator 2 according to actual needs, thereby improving the controllability of the magnetic levitation device and allowing for a broader application prospect of the magnetic levitation device.

For example, as described above, in the magnetic levitation device according to the embodiment of the present disclosure, the first magnetic stator substrate 21 includes a plurality of first protrusions 211 and a plurality of second protrusions 212; the first substrate body 210 has a circular inner edge 210e, and the plurality of first protrusions 211 and the plurality of second protrusions 212 are arranged along the circumferential direction of the circular inner edge 210e. For example, the rotor position adjusting method according to the embodiment of the present disclosure further includes: increasing the sum of first currents applied on the plurality of first magnetic levitation coils and/or decreasing the sum of second currents applied on the plurality of second magnetic levitation coils, so that the upward force in the axial direction Z applied on the rotor by the plurality of first protrusions and the plurality of first magnetic levitation coils is greater than the downward force in the axial direction Z applied on the rotor by the plurality of second protrusions and the plurality of second magnetic levitation coils, and the rotor moves upward in the axial direction of the stator under the upward resultant force; and decreasing the sum of the first currents applied on the plurality of first magnetic levitation coils and/or increasing the sum of the second currents applied on the plurality of second magnetic levitation coils, so that the upward force in the axial direction Z applied on the rotor by the plurality of first protrusions and the plurality of first magnetic levitation coils is smaller than the downward force in the axial direction Z applied on the rotor by the plurality of second protrusions and the plurality of second magnetic levitation coils, and the rotor moves downward in the axial direction of the stator under the downward resultant force. Thus, the position of the rotor 1 in the axial direction Z of the stator 2 can be simply, flexibly and accurately adjusted according to actual needs.

What is described above is related to the exemplary embodiments of the disclosure only and not limitative to the scope of the disclosure; the scope of the disclosure is defined by the accompanying claims.

1. A magnetic levitation device, comprising:
a rotor; and
a stator, wherein the stator is arranged around the rotor or the rotor is arranged around the stator, the stator comprises a permanent magnet stator body, a first magnetic stator substrate and a second magnetic stator substrate, and the permanent magnet stator body is sandwiched between the first magnetic stator substrate and the second magnetic stator substrate in an axial direction of the stator, wherein,
the first magnetic stator substrate comprises a first substrate body, as well as a first protrusion and a second protrusion which are protruding from the first substrate body towards the rotor, wherein a first magnetic levitation coil is wound on the first protrusion, and a second magnetic levitation coil is wound on the second protrusion, and the first protrusion is higher than the second protrusion in the axial direction of the stator so that the first protrusion and the first magnetic levitation coil apply an upward force in the axial direction on the rotor, and the second protrusion and the second magnetic levitation coil apply a downward force in the axial direction on the rotor.

2. The magnetic levitation device according to claim 1, wherein:
the first protrusion is higher than the second protrusion in the axial direction of the stator, comprising one of the following situations (i) to (iii):
(i) in the axial direction of the stator, an upper surface of the first protrusion is higher than an upper surface of the second protrusion, and a lower surface of the first protrusion is higher than the upper surface of the second protrusion;
(ii) in the axial direction of the stator, the upper surface of the first protrusion is higher than the upper surface of the second protrusion, and the lower surface of the first protrusion has a same height as the upper surface of the second protrusion; and
(iii) in the axial direction of the stator, the upper surface of the first protrusion is higher than the upper surface of the second protrusion, and the lower surface of the first protrusion is located between the upper surface of the second protrusion and a lower surface of the second protrusion.

3. The magnetic levitation device according to claim 1, wherein,
the rotor comprises a rotor body, as well as a first flange and a second flange protruding from the rotor body towards the stator, wherein the first flange corresponds to the first magnetic stator substrate, and the second flange corresponds to the second magnetic stator substrate;
under an initial levitation state of the rotor, a centerline of the first flange is substantially flush with a centerline of a distance between an upper surface of the first protrusion and a lower surface of the second protrusion in the axial direction of the stator;
in the case where the upward force in the axial direction applied on the rotor by the first protrusion and the first magnetic levitation coil is greater than the downward force in the axial direction applied on the rotor by the second protrusion and the second magnetic levitation coil, the rotor moves upward in the axial direction of the stator from the initial levitation state; and
in the case where the upward force in the axial direction applied on the rotor by the first protrusion and the first magnetic levitation coil is smaller than the downward force in the axial direction applied on the rotor by the second protrusion and the second magnetic levitation coil, the rotor moves downward in the axial direction of the stator from the initial levitation state.

4. The magnetic levitation device according to claim 3, wherein,
in the axial direction of the stator, a thickness of each of the first protrusion and the second protrusion is not smaller than a thickness of the first flange.

5. The magnetic levitation device according to claim 1, wherein,
the first magnetic stator substrate comprises a plurality of first protrusions and a plurality of second protrusions; and
the first substrate body has a circular inner edge, and the plurality of first protrusions and the plurality of second protrusions are arranged along a circumferential direction of the circular inner edge.

6. (canceled)

7. The magnetic levitation device according to claim 5, wherein,
one second protrusion is arranged between two adjacent first protrusions, and one first protrusion is arranged between two adjacent second protrusions;
the total number of the plurality of first protrusions is equal to the total number of the plurality of second protrusions; and
the plurality of first protrusions are uniformly arranged along the circumferential direction of the circular inner edge, and the plurality of second protrusions are uniformly arranged along the circumferential direction of the circular inner edge.

8. (canceled)

9. The magnetic levitation device according to claim 5, wherein,
one group of second protrusions is arranged between two adjacent first protrusions, and one first protrusion is arranged between two adjacent groups of second protrusions;
one group of second protrusions comprises N second protrusions, where N≥2;
the total number of the second protrusions is N times that of the first protrusions; and
the plurality of first protrusions are uniformly arranged along the circumferential direction of the circular inner edge, and a plurality of groups of second protrusions are uniformly arranged along the circumferential direction of the circular inner edge.

10. The magnetic levitation device according to claim 5, wherein,
one group of first protrusions is arranged between two adjacent second protrusions, and one second protrusion is arranged between two adjacent groups of first protrusions;
one group of first protrusions comprises M first protrusions, where M≥2;
the total number of the first protrusions is M times that of the second protrusions; and
a plurality of groups of first protrusions are uniformly arranged along the circumferential direction of the circular inner edge, and the plurality of second protrusions are uniformly arranged along the circumferential direction of the circular inner edge.

11. The magnetic levitation device according to claim 5, wherein,
one group of second protrusions is arranged between two adjacent groups of first protrusions, and one group of first protrusions is arranged between two adjacent groups of second protrusions;
one group of second protrusions comprises N second protrusions, where N≥2, and one group of first protrusions comprises M first protrusions, where M≥2, and N is equal to or different from M; and
a plurality of groups of first protrusions are uniformly arranged along the circumferential direction of the circular inner edge, and a plurality of groups of second protrusions are uniformly arranged along the circumferential direction of the circular inner edge.

12-13. (canceled)

14. The magnetic levitation device according to claim 1, wherein,
the first magnetic stator substrate comprises a first sub-substrate and a second sub-substrate, the first sub-substrate comprises the first protrusion, and the second sub-substrate comprises the second protrusion, and
the first sub-substrate is stacked on the second sub-substrate in the axial direction of the stator so that the first protrusion is higher than the second protrusion in the axial direction of the stator.

15. The magnetic levitation device according to claim 14, wherein,
a shape and a size of the first sub-substrate comprising the first protrusion are as same as a shape and a size of the second sub-substrate comprising the second protrusion, respectively.

16. The magnetic levitation device according to claim 1, wherein,
the first substrate body has a circular inner edge;
an inner edge of the first protrusion is a first arc, and an inner edge of the second protrusion is a second arc, wherein the first arc is a part of a first circle and the second arc is a part of a second circle; and
the first circle and the second circle both are concentric circles of the circular inner edge.

17. (canceled)

18. The magnetic levitation device according to claim 1, wherein,
the second magnetic stator substrate comprises a second substrate body and a plurality of teeth protruding from the second substrate body towards the rotor, and each of the plurality of teeth is wound with a magnetic rotating coil.

19. The magnetic levitation device according to claim 18, wherein,
an additional magnetic levitation coil is wound on the second substrate body, and the additional magnetic levitation coil is farther away from the rotor than the magnetic rotating coil.

20. The magnetic levitation device according to claim 19, wherein,
the second magnetic stator substrate further comprises a third protrusion and a fourth protrusion which are protruding from the second substrate body towards the rotor, wherein a third magnetic levitation coil is wound on the third protrusion, and a fourth magnetic levitation coil is wound on the fourth protrusion, and the third magnetic levitation coil and the fourth magnetic levitation coil are used as the additional magnetic levitation coil, and
the third protrusion is higher than the fourth protrusion in the axial direction of the stator, so that the third protrusion and the third magnetic levitation coil apply an upward force in the axial direction on the rotor while the fourth protrusion and the fourth magnetic levitation coil apply a downward force in the axial direction on the rotor.

21. The magnetic levitation device according to claim 1, wherein,
the first magnetic stator substrate comprises a plurality of teeth protruding from the first substrate body towards the rotor, and each of the plurality of teeth is wound with an additional magnetic rotating coil, and the first magnetic levitation coil and the second magnetic levitation coil are both farther away from the rotor than the additional magnetic rotating coil.

22. The magnetic levitation device according to claim 21, wherein,
an inner edge of the first protrusion and an inner edge of the second protrusion are respectively provided with a part of the plurality of teeth.

23. The magnetic levitation device according to claim 21, wherein,
the first magnetic stator substrate comprises a first sub-substrate, a second sub-substrate and a third sub-substrate, wherein the first sub-substrate comprises the first protrusion, the second sub-substrate comprises the second protrusion, and the third sub-substrate comprises the plurality of teeth,
the first sub-substrate is stacked on the second sub-substrate in the axial direction of the stator so that the first protrusion is higher than the second protrusion in the axial direction of the stator, and
the third sub-substrate is sandwiched between the first sub-substrate and the second sub-substrate in the axial direction of the stator.

24. (canceled)

25. A rotor position adjusting method for adjusting a position of the rotor of the magnetic levitation device according to claim 1 in the axial direction of the stator, the rotor position adjusting method comprising:
applying a first current to the first magnetic levitation coil and applying a second current to the second magnetic levitation coil;
controlling the first current to control a magnitude of the upward force in the axial direction applied on the rotor by the first protrusion and the first magnetic levitation coil; and
controlling the second current to control a magnitude of the downward force in the axial direction applied on the rotor by the second protrusion and the second magnetic levitation coil.

26. The rotor position adjusting method according to claim 25, further comprising:
increasing the first current and/or decreasing the second current, so that the upward force in the axial direction applied on the rotor by the first protrusion and the first magnetic levitation coil is greater than the downward force in the axial direction applied on the rotor by the second protrusion and the second magnetic levitation coil, and the rotor moves upward in the axial direction of the stator under an upward resultant force; and
decreasing the first current and/or increasing the second current, so that the upward force in the axial direction applied on the rotor by the first protrusion and the first magnetic levitation coil is smaller than the downward force in the axial direction applied on the rotor by the second protrusion and the second magnetic levitation coil, and the rotor moves downward in the axial direction of the stator under a downward resultant force.

27. (canceled)
